(19) United States
(12) Patent Application Publication
(10) Pub. No.: US 2009/0288759 A1
(43) Pub. Date: Nov. 26, 2009

(54) Method for Applying a Label and Labeling Unit for this Purpose

(75) Inventors: Mark Töpfer, Thurnau (DE); Michael Wagner, Kulmbach (DE); Arthur Schittek, Emmen (CH)

Correspondence Address: FAY KAPLUN & MARCIN, LLP, 150 BROADWAY, SUITE 702, NEW YORK, NY, 10038, US

(73) Assignee: Topfer Kulmbach GmbH and Papierfabriken Chm-Tenero AG

(21) Appl. No.: 12/097,188

(22) PCT Filed: Dec. 22, 2006
(86) PCT No.: PCT/EP2006/012646

§ 371 Date: Jul. 31, 2008

(30) Foreign Application Priority Data
Dec. 23, 2005 (DE) 102005061964.9
Apr. 25, 2006 (DE) 102006019125.0
May 5, 2006 (DE) 102006021056.5

(51) Int. Cl. B32B 37/12; B32B 38/00

(52) U.S. Cl. 156/230; 156/389; 156/349

(57) ABSTRACT

A method for applying a label on an object includes the following steps: an activatable adhesive coating is applied on the first side of the label which forms the rear-side in the labeled state, at least in regions; the label is stored in a labeling magazine; the label is removed from the label magazine by means of a removal pallet which has an adhesive coating; the activatable adhesive coating is activated by an activation agent and subsequently the label is applied on the object with the first side.

The invention relates to a method and a unit for labelling objects, in particular bottles, with a label. Labelling methods and corresponding units for this purpose are known in the state of the art and have been used to date wherever labels are applied on objects. The different labelling methods which are available in the state of the art are for example illustrated in the manual of labelling technology (Editors. J. Bückle, D. Leykamm, 6th edition 2001).

The processing of for example paper labels is effected by the route of wet glue labelling technology. In the case of wet glue labelling technology, the labels are coated with a glue and then applied by suitable handling appliances on the objects, i.e. preferably on bottles.

It is however disadvantageous hereby that the label, which is normally stored in a labelling magazine, must be coated with a wet glue and that then the label which is thus provided with the applied wet glue must be transported by corresponding devices to the object for application, i.e. to the bottle. This process can be implemented in fact by suitable labelling units with a corresponding rapid continuous method but the entire method, in particular the conditioning and metering of the wet glue in the machine, is complex and not always defect-free so that relatively great complexity results for maintaining and operating the system, which entails great cost disadvantages.

Starting herefrom, it is therefore the object of the present invention to propose an improved method for applying labels on objects, which can be implemented without difficulty and with a defect quota which is as low as possible.

Furthermore, it is an object of the present invention to indicate a corresponding device for applying labels.

This object is achieved with respect to the method by the features of claim 1 and, with respect to the labelling unit, by the features of claim 21. The further dependent claims demonstrate advantageous developments.

According to the invention, it is hence proposed to apply an activatable adhesive coating on the side of the label which forms the rear-side in the labelled state and that then these thus pre-treated labels are removed dry from the label magazine by means of a removal pallet which has an adhesive coating and, in the further course of the method, then are transported to the object for application, i.e. to the bottle. Before the label is then applied on the bottle, activation of the adhesive and then immediately thereafter application on the bottles are effected.

The labels can thereby be stored with the side which forms the first side lying outwards or even lying inwards in the label magazine.

The crucial advantage of the method according to the invention thus resides in the fact that the operation takes place with a “dry” adhesive so that dry removal of the label is possible. Subsequently, activation of the adhesive coating is then effected. Hence, a wet glue, as known to date in the state of art, can be dispensed with.

There are suitable in particular as activatable adhesive coating those which are based on natural biopolymers and also derivatives thereof and/or synthetic polymers. Examples of adhesive coatings of this type are: caseins, proteins, alginates, gelatines, galactoglucomannans, starch, chitin and derivatives thereof, vinyl alcohol (VAL), vinyl acetate (VAC), acrylic acid and derivatives thereof, carboxymethylcellulose (CMC).

It is thereby preferred if the activatable adhesive coating comprises 60 to 100%, preferably 70 to 95%, in particular 80 to 95%, of a starch derivative and 0 to 40%, preferably up to 30%, in particular 5 to 20%, of a polymer which acts as thickener and is based on a natural or synthetic basis. It is thereby advantageous if the activatable adhesive coating has a solids content of 10 to 70%, preferably 10 to 40%, in particular 20 to 30%. Furthermore, it emerged as favourable if the viscosity is in the range of 20 to 4,000 mPas, preferably 400 to 3,000 mPas, in particular at 800 to 2,500 mPas (Brookfield). However, the invention basically comprises all other adhesive coatings which can be applied on a substrate and activated subsequently by means of an activation agent.

According to the present invention, preferably water and/or water vapour and/or a water/alcohol mixture are suitable as activation agent.

In addition to the activatable adhesive coating, there should be mentioned as further essential element of the invention, the removal pallet which is provided with an adhesive coating. Surprisingly, the inventors were now able to show that a removal pallet which has preferably a permanently adhesive coating is suitable for removing the label from the label magazine by means of contact with the surface of the label, preferably even with the dry adhesive coating of the label, and transporting it further. In order to achieve as permanent an adhesive state as possible of the removal pallet and hence a disturbance-free operation, it is provided in addition according to the invention that cleaning devices for the surface of the removal pallet with the adhesive coating are provided in order to free the latter of impurities in order not to impair the adhesive effect. A cleaning device of this type can, in the simplest case, comprise a spray device which sprays down the surface and/or also a suitable cleaning roller and/or cleaning belt.

The permanently adhesive coating of the removal pallet is preferably achieved with an elastic material based on silicone, thermoplastic elastomers and/or polyurethane. These plastic materials which are used thereby preferably have an adhesive force which is present throughout within the entire material composite, i.e. not only on the surface. A special silicone-containing material is obtainable for example with the trade name Smart Pad® by the company Akzent. The method according to the invention is thereby preferably implemented such that the labels are removed individually, preferably continuously or in a cycle, from the label magazine.

With respect to the labels, the invention concerns labels which comprise both paper and film.

There are understood by labels comprising paper according to the present invention, paper labels, on the one hand, and also composite labels, i.e. labels which comprise a paper layer and a further layer, for example a plastic material layer. The plastic material layer can thereby be laminated on the paper label. In the case of labels of this type, it is then necessary that the activatable adhesive coating is applied on the paper side. Of course, in the case of the method according to the invention, a paper label can also be used which comprises two or more different laminated-together paper layers.

There are understood by labels comprising film according to the present invention, film labels, on the one hand, and also composite labels, i.e. labels which comprise a film layer and a further layer, for example a plastic material layer which is different from the film layer. The plastic material layer can thereby be laminated on the film label. In the case of labels of this type, it is then favourable that the activatable adhesive coating is applied on the film side. Of course, in the case of the method according to the invention, a film label can also be used which comprises two or more different laminated-together film layers.

Activation of the activatable adhesive coating is effected preferably with a spray device. There are suitable as suitable activation media thereby in particular water which can be also water vapour or even mixtures of water with organic solvents, such as alcohols or ketones. The selection of the activation agent is effected as a function of the selected adhesive coating.

Furthermore, the invention relates to a labelling unit for labelling objects with a label.

The labelling unit according to the invention is constructed per se as in the state of the art but the labelling unit according to the invention has in the removal region the particular feature with respect to the removal pallet that the removal pallet is provided, on the side with which contact with the label is then effected, with a durable, adhesively acting coating. The permanently adhesive coating of the removal pallet is preferably achieved with an elastic material based on silicone, thermoplastic elastomers and/or polyurethane. These plastic materials which are used thereby have an adhesive force which is present throughout within the entire material composite, i.e. not only on the surface. A further modification of the labelling unit according to the invention resides in the fact that means are provided also in addition for activating the adhesive coating, e.g. in the form of nozzles, which are disposed such that spraying of the surface of the label can be effected before application.

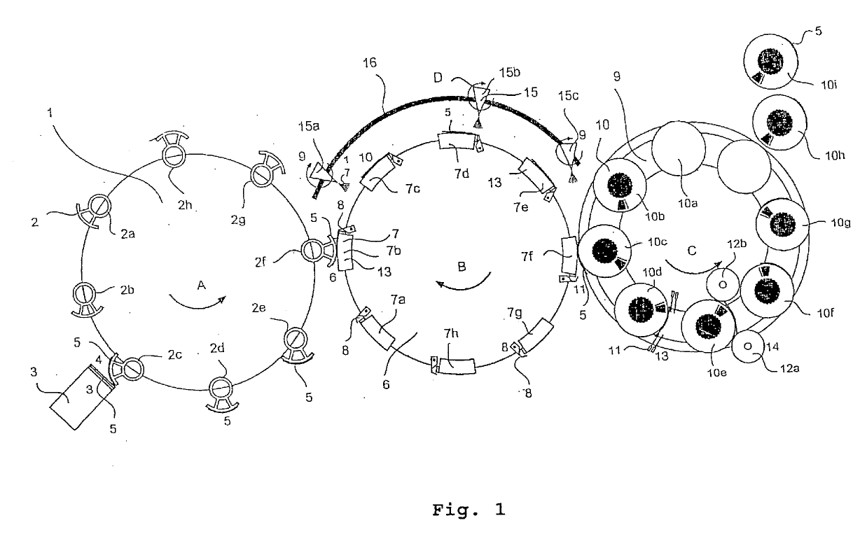

One embodiment of the invention is explained subsequently in more detail with reference to FIG. 1. In this embodiment, the labels are stored with the rear-side outwards in the label magazine; the removal region and also the activation region are present separated from each other spatially and form separate functional units in the form of carousels. As an alternative, an embodiment is likewise conceivable in which the functional features of the activation region are incorporated in that of the removal region. Hence, no spatial separation of the two carousels would be required. In total, only two carousels would hence be present in the device according to the invention.

In FIG. 1, a pallet carousel 1 (removal region), a gripper carousel 6 (activation region) and also a packing carousel 9 (application region) are represented, by means of which a label 5 from a label magazine 3 is applied on one of the packs 10a to 10i.

The pallet carousel 1 has at least one removal pallet 2. In FIG. 1, this removal pallet 2 is represented in various positions 2a to 2h. The pallet carousel 1 thereby rotates in the direction of the arrow A and the removal pallet 2 likewise rotates independently about its axis of rotation. In the removal region, also a cleaning device for the surface of the removal pallet can be provided in addition (not illustrated).

The removal pallet 2 with the permanently acting adhesive coating is pivoted, after cleaning down at the cleaning device, subsequently into the position 2b and passes by a label magazine 3 in which individual, for example stamped or cut paper labels 5 are stacked. On their outer side, the paper labels have an activatable adhesive coating. The removal pallet 2 rolls on the label 5 which has its rear-side lying upwards and is uppermost in the label magazine 3 and removes said label as a result dry. Upon further rotation of the pallet carousel 1, the removal pallet 2 which is provided with a label 5 is transported up to a region in which it is situated directly opposite the gripper carousel 6. The gripper carousel 6 has at least one gripper device 7 which is represented here in its different positions 7a to 7h. The gripper carousel 6 thereby rotates in the direction of the arrow B (activation region).

The individual gripper device 7 has a gripper finger 8 with which a label 5 is clamped securely between a gripper support and the gripper finger 8.

In the position 7b, the gripper device 7 takes over the label situated in position 2f from the removal pallet 2. The label 5 is transported in this way with its rear-side outwards.

The gripper carousel 6 then rotates subsequently now until the gripper device 7 is situated in position 7f opposite the packing carousel (application region).

The packing carousel 9 now transports packs 10 which are represented in their individual positions 10a to 10i past the gripper in position 7f. The packing carousel 9 thereby rotates in the direction of the arrow C and the packs 10, for their part, rotate about their own vertical axis.

In position 10c, the packs now take over from the gripper device 7, in position 7f, the label 5 which comes to be situated with its activated adhesive coating on the pack 10.

In position 10d, the label is then pressed on by means of pressure brushes 11 and, in position 10e, the label is pressed further onto the pack 10 by means of pressure rollers 12a and 12b. In position 10h, the labelled pack leaves the label carousel 9.

It is now crucial that an activation device is disposed in the region between the removal region (A) and the application region (C). This moistening device 15 can be disposed within the region which is provided with the reference number 16 in FIG. 1 and represented as a bar. In FIG. 1, three different positions 15a to 15c are represented by way of example. The moistening device 15 in FIG. 1 is a spray device for applying a water film on the rear-side of the label which is retained by the gripping device 7. The spray device 15 can thereby be mounted pivotably or oscillating in the direction of the arrow D in order to cover the entire label 5 with the spray jet 17.

1-26. (canceled)

27. A method for applying a label on an object, comprising:
applying an activatable adhesive coating on a first side of the label which forms a rear-side in a labeled state at least in regions;
storing the label in a labeling magazine;
removing the label from the label magazine using a removal pallet which has an adhesive coating;
activating the activatable adhesive coating by an activation agent; and
after the activating step, applying the label on the object with the first side.

28. The method according to claim 27, wherein the label is stored with a side which forms the first side lying outwards in the label magazine.

29. The method according to claim 27, wherein the label is stored with a side which forms the first side lying inwards in the label magazine.

30. The method according to claim 27, wherein the activatable adhesive coating includes an activatable adhesive material which is selected on a basis of at least one of biopolymers, derivatives thereof and synthetic polymers, the material being activatable with liquid.

31. The method according to claim 30, wherein the material is selected from a group comprising caseins, proteins, alginates, gelatines, galactoglucomannans, starches, chitin and derivatives thereof, vinyl alcohol (VAL), vinyl acetate (VAC), acrylic acid and derivatives thereof and also carboxymethylcellulose (CMC).

32. The method according to claim 30, wherein the material comprises 60 to 100% of a starch derivative and 0 to 40% of a polymer which acts as thickener and is based on one of a natural basis and a synthetic basis.

33. The method according to claim 30, wherein the material comprises 70 to 95% of a starch derivative and 5 to 30% of a polymer which acts as thickener and is based on one of a natural basis and a synthetic basis.

34. The method according to claim 30, wherein the material comprises 80 to 95% of a starch derivative and 5 to 20% of a polymer which acts as thickener and is based on one of a natural basis and a synthetic basis.

35. The method according to claim 30, wherein the material has a solids content of 10 to 70%.

36. The method according to claim 30, wherein the material has a solids content of 10 to 40%.

37. The method according to claim 30, wherein the material has a solids content of 20 to 30%.

38. The method according to claim 30, wherein the material has a viscosity of 200 to 4,000 mPas (Brookfield).

39. The method according to claim 30, wherein the material has a viscosity of 400 to 3,000 mPas (Brookfield).

40. The method according to claim 30, wherein the material has a viscosity of 800 to 2,500 mPas (Brookfield).

41. The method according to claim 27, wherein the activation agent includes at least one of water, water vapour and a water/alcohol mixture.

42. The method according to claim 27, wherein the adhesive coating of the removal pallet has a permanently adhesive behavior.

43. The method according to claim 27, wherein the adhesive coating of the removal pallet includes an elastic material which is based on at least one of silicone, thermoplastic elastomers and polyurethane.

44. The method according to claim 27, wherein the label includes one of paper, a paper label and a paper composite label.

45. The method according to claim 44, wherein the paper composite label comprises paper and at least one further layer comprising a composite material.

46. The method according to claim 27, wherein the label includes one of a film, a film label and a film composite label.

47. The method according to claim 46, wherein the film composite label comprises a film and at least one further layer made of composite material.

48. The method according to claim 27, wherein the label, in a removal region, is removed one of continuously and in a cycle from the label magazine with at least one removal pallet which has the adhesive coating, and wherein the label, in an activation region, is guided past at least one device for activating the activatable adhesive coating and subsequently, in an application region, is applied on the object.

49. The method according to claim 48, wherein in the removal region, a cleaning device cleans the adhesive coating of the removal pallet.

50. The method according to claim 49, wherein the device is disposed such that the cleaning is effected before removal of the label.

51. The method according to claim 48, wherein in the activation region, at least one spray device sprays the activatable adhesive coating.

52. The method according to claim 27, wherein the label is applied on a bottle.

53. A labeling unit for labeling an object, comprising:
a label having at least one removal region, at least one activation region and at least one application region for applying the label on the object;
a label magazine storing the label;
at least one removal pallet removing the label individually from the label magazine, the removal region being formed by the at least one removal pallet which has an adhesive coating.

54. The labeling unit according to claim 53, wherein the removal region and the activation region are separated from each other spatially.

55. The labeling unit according to claim 53, wherein the removal region and the activation region coincide spatially.

56. The labeling unit according to claim 53, further comprising:
a cleaning device cleaning the adhesive coating of the removal pallet, the cleaning device situated in a removal region.

57. The labeling unit according to claim 56, wherein the cleaning device includes at least one of a cleaning roller, a spray device and a cleaning belt.

58. The labeling unit according to claim 53, further comprising:
at least one spray device spraying the activatable adhesive coating, the spray device situated in an activation region.
